(19) United States
(12) Patent Application Publication
(10) Pub. No.: US 2010/0312367 A1
(43) Pub. Date: Dec. 9, 2010

(54) Interactive Sports Game Reality System and Method

(75) Inventor: Bester Tauya Zambuko, Lonehill (ZA)

Correspondence Address: BAKER & DANIELS LLP, 300 NORTH MERIDIAN STREET, SUITE 2700, INDIANAPOLIS, IN, 46204, US

(73) Assignee: BEST SELLER BRANDS (PTY) LTD, Sunninghill (ZA)

(21) Appl. No.: 12/793,203

(22) Filed: Jun. 3, 2010

(30) Foreign Application Priority Data
Jun. 4, 2009 (ZA) 200903892

(51) Int. Cl. G06F 19/00

(52) U.S. Cl. 700/91

(57) ABSTRACT

The present invention involves an interactive sports game reality system in which members of the public can collectively influence at least one factor affecting an upcoming sports game event. A receiver receives input data from members of the public in connection with at least one factor. A processor compiles the received input data and determines the overall result regarding the at least one factor. An output device outputs the determined overall result for implementation at or during the sports game event. The at least one factor comprises at least one option, each option having an associated data code to facilitate the selection and communication of the option for each factor. The receiver receives input data from members of the public in connection with the at least one factor during a predetermined period before the sports game event, in which case the at least one factor is selected from the group comprising venue for the sports game event, the teams participating in the sports game event, the referees adjudicating the sports game event, the composition of teams participating in the sports game event and rules governing the sports game event. In one version, for example, the predetermined period before the sports game event is a TV programme, or one of a number of TV programmes, during which the members of the public can send input data to the receiver.

### FIELD OF THE INVENTION

This invention relates to an interactive sports game reality system and method, in which members of the public can interact and influence factors or elements of a sports game, and in particular soccer.

### BACKGROUND OF THE INVENTION

Soccer is an extremely popular sports game followed and supported by millions of people around the world. South Africa is particularly unique in that will be hosting the 2010 Soccer World Cup and so soccer fever will be an integral part of South African society for months, if not years, to come.

However, currently soccer is a spectator sport, with supporters supporting his or her particular team, but having no substantial influence on factors affecting a particular game, such as team composition, referee selection and venue for the game.

It is therefore an aim of the present invention to provide a sports game reality system and method in which spectators can influence factors affecting a particular game, and thereby interact with the game in a direct and personal manner.

### SUMMARY OF THE INVENTION

In accordance with a first aspect of this invention, there is provided an interactive sports game reality system in which members of the public can collectively influence at least one factor affecting an upcoming sports game event, the system comprising:
a receiver to receive input data from members of the public in connection with the at least one factor;
a processor to compile the received input data and to determine the overall result regarding the at least one factor; and
an output device to output the determined overall result for implementation at or during the sports game event.

In an embodiment, the at least one factor comprises at least one option, each option having an associated data code to facilitate the selection and communication of the option for each factor.

In an embodiment, the receiver receives input data from members of the public in connection with the at least one factor during a predetermined period before the sports game event, in which case the at least one factor is selected from the group comprising venue for the sports game event, the teams participating in the sports game event, the referees adjudicating the sports game event, the composition of teams participating in the sports game event and rules governing the sports game event. In one version, for example, the predetermined period before the sports game event is a TV programme, or one of a number of TV programmes, during which the members of the public can send input data to the receiver.

In an alternate or additional embodiment, the receiver receives input data from members of the public in connection with the at least one factor during a predetermined period during the sports game event, in which case the at least one factor is selected from the group comprising substitutions of players during the sports game event and the positions of players during the sports game event.

In an embodiment, the member of the public uses an input device to compile and send his/her input data to the receiver via a communications network associated with the input device. The input device may be selected from the group comprising a cellular telephone, in which case the data input may be sent as a text message via a cellular communications network or determined from an IVR-driven process, a landline telephone, in which case the data input may be determined from an IVR-driven process, and a computer, in which case the data input may be sent as an e-mail or a clicked option on an internet web page via a computer data network, such as the internet, in which the processor may be in communication with a web server. The computer in turn may be a cellular telephone, a portable handheld device or any computing-type device.

In an embodiment, the output device comprises a broadcast module to broadcast the determined overall result regarding the at least one factor, as a television or radio signal, an SMS text message to a predetermined group of recipients or as an internet web page via the web server.

In an embodiment, the receiver is arranged to acknowledge receipt of the received input data from the members of the public.

In an embodiment, the web server hosts a web site on which the determined overall result regarding the at least one factor is displayed. The web site can also be used by the members of the public can exchange comments.

There is also provided for the live sports event to be selected from, but not limited to, the group consisting of soccer, rugby, cricket, tennis, baseball and basketball.

In broad terms, and in accordance with a second aspect of this invention, there is provided a method of running an interactive sports game in which members of the public can collectively influence at least one factor affecting an upcoming sports game event, the method comprising:
receiving input data from members of the public in connection with the at least one factor;
compiling the received input data and determining the overall result regarding the at least one factor; and
outputting the determined overall result for implementation at or during the sports game event.

In an embodiment, the method comprises receiving input data from members of the public in connection with the at least one factor during a predetermined period before the sports game event, in which case the at least one factor is selected from the group comprising venue for the sports game event, the teams participating in the sports game event, the referees adjudicating the sports game event, the composition of teams participating in the sports game event and rules governing the sports game event.

In an alternate or additional embodiment, the method comprises receiving input data from members of the public in connection with the at least one factor during a predetermined period during the sports game event, in which case the at least one factor is selected from the group comprising substitutions of players during the sports game event and the positions of players during the sports game event.

In an embodiment, the step of outputting the determined overall result comprises broadcasting the determined overall result regarding the at least one factor, as a television or radio signal, an SMS text message to a predetermined group of recipients or as an internet web page.

In an embodiment, the method comprises acknowledging receipt of the received input data from the members of the public.

In broad terms, and in accordance with a third aspect of this invention, there is provided an interactive sports game reality system in which members of the public can collectively influence at least one factor affecting an upcoming sports game event, the system comprising:
means for receiving input data from members of the public in connection with the at least one factor;
means for compiling the received input data and determining the overall result regarding the at least one factor; and
means for outputting the determined overall result for implementation at or during the sports game event.

In broad terms, and in accordance with a fourth aspect of this invention, there is provided an interactive sports game reality system in which members of the public can collectively influence at least one factor affecting an upcoming sports game event, the system comprising a processor that is arranged to:
receive input data from members of the public in connection with the at least one factor;
compile the received input data and determining the overall result regarding the at least one factor; and
output the determined overall result for implementation at or during the sports game event.

### BRIEF DESCRIPTION OF THE DRAWINGS

A preferred embodiment of the invention will be described, by way of example only, with reference to the drawings in which:

FIG. 1 is a schematic block diagram of an interactive sports game reality system according to an embodiment of the present invention; and

FIG. 2 is a schematic flow chart representing a method of running an interactive sports game according to an embodiment of the present invention.

### DESCRIPTION OF PREFERRED EMBODIMENTS

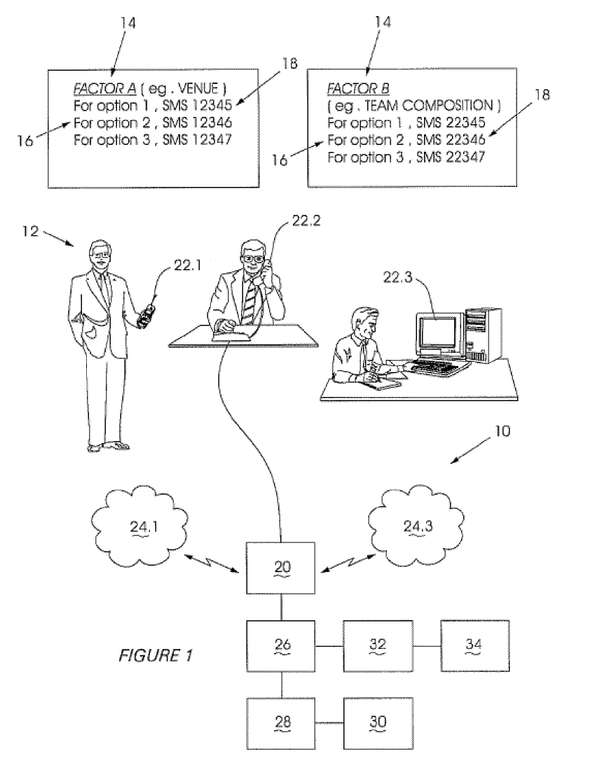

Referring first to FIG. 1, an interactive sports game reality system 10 in which members 12 of the public can collectively influence at least one factor 14 affecting an upcoming sports game event is provided. Typically, the at least one factor 14 comprises at least one option 16, each option 16 having, for example, an associated data code 18, or some other structure or arrangement, to facilitate the selection and communication of the option 16 for each factor 14.

The system 10 comprises a receiver 20 to receive input data from members 12 of the public in connection with the at least one factor 14. In an embodiment, the receiver 20 receives input data from members 12 of the public in connection with the at least one factor during a predetermined period before the sports game event. In this case, the at least one factor 14 is selected from the group comprising venue for the sports game event, the teams participating in the sports game event, the referees adjudicating the sports game event, the composition of teams participating in the sports game event and rules governing the sports game event. This will be explained in more detail further on in the specification.

In one version, for example, the predetermined period before the sports game event is a TV programme, or one of a number of TV programmes, during which the members 12 of the public can send input data. Again, this will be explained in more detail further on in the specification.

In an alternate or additional embodiment, the receiver 20 receives input data from members 12 of the public in connection with the at least one factor 14 during a predetermined period during the sports game event. In this case, the at least one factor 14 is selected from the group comprising substitutions of players during the sports game event and the positions of players during the sports game event.

In an embodiment, the member 12 of the public uses an input device 22 to compile and send his/her input data to the receiver 20 via a communications network 24 associated with the input device 22. The input device 22 may be selected from the group comprising a cellular telephone 22.1, in which case the data input may be sent as a text message via a cellular communications network 24.1 or determined from an interactive voice response driven (IVR-driven) process, a landline telephone 22.2, in which case the data input may be determined from an IVR-driven process, and a computer 22.3, in which case the data input may be sent as an e-mail or a clicked option on an internet web page via a computer data network 24.3, such as the internet. The computer 22.3 in turn may be a cellular telephone, a portable handheld device or any computing-type device.

The interactive sports game reality system 10 further comprises a processor 26 to compile the received input data and to determine the overall result regarding the at least one factor 14.

The system 10 further comprises an output device 28 to output the determined overall result for implementation at or during the sports game event. In an embodiment, the output device 28 comprises a broadcast module 30 to broadcast the determined overall result regarding the at least one factor, as a television or radio signal, an SMS text message to a predetermined group of recipients or as an internet web page via the web server.

In an embodiment, the receiver 20 is arranged to acknowledge receipt of the received input data from the members 12 of the public.

In an embodiment, a web server 32, which may be connected to the processor 26, hosts a web site 34 on which the determined overall result regarding the at least one factor 14 is displayed. The web site 34 can also be used by the members 12 of the public can exchange comments.

There is also provided for the live sports event to be selected from, but not limited to, the group consisting of soccer, rugby, cricket, tennis, baseball and basketball. With the soccer fever currently in South Africa, it is envisaged that this invention will first be implemented using soccer.

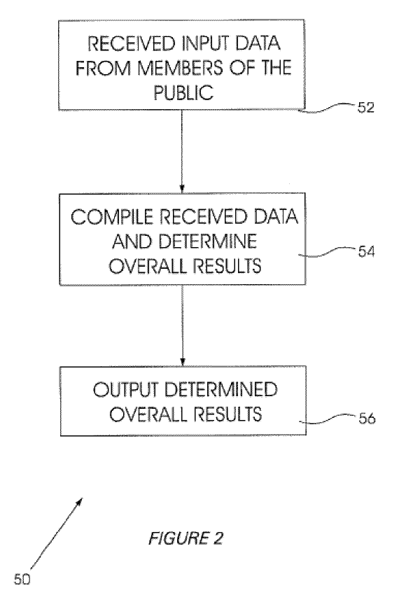

Turning now to FIG. 2, in accordance with a second aspect of this invention, there is provided a method 50 of running an interactive sports game in which members of the public can collectively influence at least one factor affecting an upcoming sports game event. The method comprises receiving input data from members of the public in connection with the at least one factor, as indicated by block 52, compiling the received input data and determining the overall result regarding the at least one factor, as indicated by block 54, and outputting the determined overall result for implementation at or during the sports game event, as indicated by block 56.

Thus, for example, in one application of the invention, it is envisaged that a hyped-up soccer tournament between 3 rival teams will be held, the soccer tournament being based on members of the public's perception of how the game should be structured, both from a team point of view as well as rules governing the tournament. The overall running of the tournament will comprise 10 television programmes and 3 live matches. There will be 3 television programmes before each live match, with the 10^{th} programmes being a prize-giving programme.

As indicated above, members of the public select their ideal line-up for their teams by way of SMS voting, to provided short code numbers (data code 18 shown in FIG. 1). In addition, a line-up of match officials is also provided, and again the members of the public may vote for match officials of their choice using SMS voting based on short code numbers. The members of the public also determine certain rules regarding the games, such as how to decide a winner in the event of a draw, again using SMS voting based on short code numbers. Finally, the members of the public also determine the venues for each of the games, again using SMS voting based on short code numbers.

In more detail, it is envisaged that each TV programme will commence with a live sponsored TV programme hosted by 2 anchors. The programme would be themed around soccer, with particular emphasis on the 3 participating teams that are to participate in the tournament. A historic overview of the teams may be provided to generate public interest and participation. A line up of 2 well known teams is provided, each consisting of 20 players. Short code numbers are provided for each player, to which members of the public will be SMSing to vote for the players they want to see represent the team of their choice. In so doing, the members of the public can influence or “fix” the upcoming game, with the “fixing” extending to match officials as well. Typically, again, approximately 8 well known match officials are provided, each with their own short code number, to which the members of the public can SMS in order to vote for a particular match official to officiate in the matches. As indicated above, the members of the public can also vote on how to decide a winner in the event of a draw—again, each option, such as penalties, golden goal, sudden death or full extra time will have an associated short code number to which the member of the public can send an SMS to vote.

There are no restrictions on the number of times that a person can SMS an option, and for example, tactically, a person may even vote for a weaker player for the opposing side, thereby enhancing the interactivity and fun element of the overall tournament.

Towards the end of the programme, during the show, the results of the votes are tallied to see the progress of the voting. The final results are then conveyed either at the end of the programme or afterwards.

After every 3 programmes, a match takes place based on the overall voting results of the previous 3 programmes, with an overall winner being decided after the third match.

In one version, during the 3^{rd}, 6^{th} and 9^{th} TV programmes, i.e. immediately before the match, one lucky guest is selected and invited onto the TV programme. The guest may then finalise the selection of his/her chosen team for that particular week by being the presiding “team official” for that week. This person will also get to sit with the coaches on match day.

The present invention thus provides a sports game reality system and method, in which members of the public can interact and influence factors or elements of a sports game, and in particular soccer in a fun and interactive manner.

1. An interactive sports game reality system in which members of the public can collectively influence at least one factor affecting an upcoming sports game event, the system comprising:
a receiver to receive input data from members of the public in connection with the at least one factor;
a processor to compile the received input data and to determine the overall result regarding the at least one factor; and
an output device to output the determined overall result for implementation at or during the sports game event.

2. The interactive sports game reality system of claim 1, wherein the receiver receives data wherein the at least one factor comprises at least one option, each option having an associated data code to facilitate the selection and communication of the option for each factor.

3. The interactive sports game reality system of claim 2, wherein the receiver receives input data from members of the public in connection with the at least one factor during a predetermined period before the sports game event.

4. The interactive sports game reality system of claim 3, wherein the receiver receives data wherein the at least one factor is selected from the group comprising venue for the sports game event, the teams participating in the sports game event, the referees adjudicating the sports game event, the composition of teams participating in the sports game event and rules governing the sports game event.

5. The interactive sports game reality system of claim 3, wherein the receiver receives the input data during the predetermined period before the sports game event is a TV programme, or one of a number of TV programmes, during which the members of the public can send input data to the receiver.

6. The interactive sports game reality system of claim 2, wherein the receiver receives input data from members of the public in connection with the at least one factor during a predetermined period during the sports game event.

7. The interactive sports game reality system of claim 6, wherein the at least one factor is selected from the group comprising substitutions of players during the sports game event and the positions of players during the sports game event.

8. The interactive sports game reality system of claim 3, wherein the receiver receives input data from a member of the public that uses an input device to compile and send his/her input data to the receiver via a communications network associated with the input device.

9. The interactive sports game reality system of claim 8, wherein the receiver receives input data from the input device is a cellular telephone, a landline telephone, or a computer.

10. The interactive sports game reality system of claim 9, wherein the receiver receives input data from the input device which is a cellular telephone, the data input is sent as a text message via a cellular communications network or determined from an IVR-driven process.

11. The interactive sports game reality system of claim 9, wherein the receiver receives input data from the input device which is a landline telephone, the data input is determined from an IVR-driven process.

12. The interactive sports game reality system of claim 9, wherein the receiver receives input data from the input device which is a computer, the data input is sent as an e-mail or a clicked option on an internet web page via a computer data network.

13. The interactive sports game reality system of claim 12, wherein the receiver receives input data from the computer data network which is the internet, and wherein the processor is in communication with a web server.

14. The interactive sports game reality system of claim 12, wherein the receiver receives input data from the computer which is a cellular telephone, a portable handheld device or a computing-type device.

15. The interactive sports game reality system of claim 1 wherein the output device comprises a broadcast module to broadcast the determined overall result regarding the at least one factor, as a television or radio signal, an SMS text message to a predetermined group of recipients or as an internet web page.

16. The interactive sports game reality system of claim 15, wherein the receiver is arranged to acknowledge receipt of the received input data from the members of the public.

17. The interactive sports game reality system of claim 13, wherein the web server hosts a web site on which the determined overall result regarding the at least one factor is displayed, the web site also providing a platform on which the members of the public can exchange comments.

18. The interactive sports game reality system of claim 1 wherein the live sports event is selected from the group of live sports events consisting of soccer, rugby, cricket, tennis, baseball and basketball.

19. A method of running an interactive sports game in which members of the public can collectively influence at least one factor affecting an upcoming sports game event, the method comprising:
receiving input data from members of the public in connection with the at least one factor;
compiling the received input data and determining the overall result regarding the at least one factor; and
outputting the determined overall result for implementation at or during the sports game event.

20. The method of claim 19, wherein the method further comprises receiving input data from members of the public in connection with the at least one factor during a predetermined period before the sports game event.

21. The method of claim 20, wherein the at least one factor is selected from the group comprising venue for the sports game event, the teams participating in the sports game event, the referees adjudicating the sports game event, the composition of teams participating in the sports game event and rules governing the sports game event.

22. The method of claim 19, the method further comprises receiving input data from members of the public in connection with the at least one factor during a predetermined period during the sports game event.

23. The method of claim 22, wherein the at least one factor is selected from the group comprising substitutions of players during the sports game event and the positions of players during the sports game event.

24. The method of claim 19 wherein the step of outputting the determined overall result comprises broadcasting the determined overall result regarding the at least one factor, as a television or radio signal, an SMS text message to a predetermined group of recipients, or as an internet web page.

25. The method of any of claim 19 the method further comprises acknowledging receipt of the received input data from the members of the public.

26. An interactive sports game reality system in which members of the public can collectively influence at least one factor affecting an upcoming sports game event, the system comprising:
means for receiving input data from members of the public in connection with the at least one factor;
means for compiling the received input data and determining the overall result regarding the at least one factor; and
means for outputting the determined overall result for implementation at or during the sports game event.

27. An interactive sports game reality system in which members of the public can collectively influence at least one factor affecting an upcoming sports game event, the system comprising a processor that is arranged to:
receive input data from members of the public in connection with the at least one factor;
compile the received input data and determining the overall result regarding the at least one factor; and
output the determined overall result for implementation at or during the sports game event.
